(19) United States
(12) Patent Application Publication
(10) Pub. No.: US 2026/0333263 A1
(43) Pub. Date: Oct. 22, 2026

(54) DATA MODEM RADIO INTERFACE EMULATOR NETWORK

(71) Applicant: Aeronix, Inc., Melbourne, FL (US)

(72) Inventor: John Shoemaker, Melbourne, FL (US)

(73) Assignee: Aeronix, Inc., Melbourne, FL (US)

(21) Appl. No.: 19/654,944

(22) Filed: Apr. 22, 2026

Related U.S. Application Data
(60) Provisional application No. 63/792,568, filed on Apr. 22, 2025.

(51) Int. Cl. H04W 56/00; H04W 40/04; H04W 88/18

(52) U.S. Cl. CPC H04W 56/003; H04W 40/04; H04W 88/18

(57) ABSTRACT

An apparatus for emulating radio frequency connectivity among a plurality of channels includes a plurality of channel connectors, each channel connector configured to interface with a respective data modem, and a clock generation circuit configured to generate clock signals at a selectable baud rate provided to the plurality of channel connectors. A data routing circuit is coupled to the plurality of channel connectors and configured to receive digital data from a transmitting channel and selectively route the received digital data to one or more receiving channels based on a connectivity configuration. A controller is coupled to the data routing circuit and the clock generation circuit and configured to detect a keying signal asserted by a data modem connected to the transmitting channel and, in response to detecting the keying signal, initiate transmission of the clock signals to the transmitting channel after a configurable delay period.

### RELATED APPLICATIONS

This application claims priority under 35 U.S.C. § 119(e) of U.S. Provisional Patent Application Ser. No. 63/792,568 (Attorney Docket No. 1949.00051) filed on Apr. 22, 2025 and titled IMPROVED DATA MODEM RADIO INTERFACE EMULATOR NETWORK. The content of this application is incorporated herein by reference.

### FIELD OF THE INVENTION

The present invention relates to systems and methods for data modem communication systems, and more particularly to an apparatus and method for emulating radio frequency connectivity among a plurality of data modem channels without requiring an actual radio frequency environment.

### BACKGROUND OF THE INVENTION

Data modems are widely used in communication systems to transmit digital information over various transmission media. In tactical data link applications, data modems interface with radio equipment to enable the exchange of digital data between multiple nodes in a network. The interface between a data modem and a radio typically involves various signaling protocols, which may include keying signals to initiate transmission, clock signals for synchronous data transfer, and data signals carrying the actual information.

Testing and development of data modem systems often requires the ability to verify proper operation of multiple modem channels in a networked configuration. Traditionally, such testing has required the use of actual radio frequency equipment and an RF environment to establish connectivity among the modem channels. This approach can be costly, complex, and may require specialized facilities or spectrum allocations to conduct testing without interfering with other radio systems.

The interface between a data modem and a radio may take various forms depending on the specific application and equipment involved. Some interfaces utilize analog signaling, where the modem performs baseband modulation and demodulation of data signals. Other interfaces employ synchronous serial digital signaling, where clock signals coordinate the transfer of digital data between the modem and radio. Different keying mechanisms may also be employed, such as push-to-talk signals commonly used with analog interfaces or request-to-send signals used with digital interfaces.

When multiple data modem channels need to communicate with one another, the connectivity among channels determines which channels can receive transmissions from other channels. In an actual RF environment, this connectivity is established through the radio frequency propagation characteristics and radio configurations. Replicating such connectivity relationships for testing purposes without an RF environment presents various challenges.

Therefore, improved systems and methods for facilitating data modem testing and development are desired.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to an apparatus for emulating radio frequency connectivity among a plurality of channels. The apparatus may include a plurality of channel connectors, each channel connector configured to interface with a respective data modem. The apparatus may include a clock generation circuit configured to generate clock signals at a selectable baud rate, the clock signals provided to the plurality of channel connectors. The apparatus may include a data routing circuit coupled to the plurality of channel connectors, the data routing circuit configured to receive digital data from a transmitting channel of the plurality of channel connectors and selectively route the received digital data to one or more receiving channels of the plurality of channel connectors based on a connectivity configuration. The apparatus may include a controller coupled to the data routing circuit and the clock generation circuit, the controller configured to detect a keying signal asserted by a data modem connected to the transmitting channel and, in response to detecting the keying signal, initiate transmission of the clock signals to the transmitting channel after a configurable delay period.

According to other aspects of the present disclosure, the apparatus may include one or more of the following features. The keying signal may include one of a push-to-talk signal or a request-to-send signal, and the controller may be further configured to select which of the push-to-talk signal or the request-to-send signal to monitor for each channel. The clock generation circuit may be configured to generate a gated clock signal that is initiated in response to the keying signal being asserted. The clock generation circuit may be configured to generate a continuous clock signal, and the controller may be further configured to assert a clear-to-send signal to the transmitting channel after the configurable delay period to qualify clock edges for data transfer. The apparatus may further include a user interface coupled to the controller, the user interface configured to receive user input to modify the connectivity configuration. The user interface may include a touchscreen display configured to display a main menu including channel selection buttons and connectivity status indicators for each of the plurality of channel connectors. The apparatus may further include a power distribution circuit configured to selectively provide power to each of the plurality of channel connectors based on a channel power configuration. The data routing circuit may be further configured to receive analog data from the transmitting channel and selectively route the received analog data to the one or more receiving channels based on the connectivity configuration. The apparatus may further include a plurality of status indicators, each status indicator associated with a respective channel connector and configured to indicate at least one of a power status, a transmit status, a receive status, or a keyed status for the respective channel. The apparatus may further include a host interface coupled to the controller, the host interface configured to receive commands from an external host device to modify the connectivity configuration and operational parameters of the apparatus.

According to another aspect of the present disclosure, a radio interface emulator system may be provided. The radio interface emulator system may include a housing having a front panel and a rear panel. The radio interface emulator system may include a plurality of channel connectors disposed on the rear panel, each channel connector configured to connect to a data modem channel. The radio interface emulator system may include a display disposed on the front panel and configured to present a user interface for configuring the radio interface emulator system. The radio interface emulator system may include processing circuitry disposed within the housing and coupled to the plurality of channel connectors and the display, the processing circuitry configured to emulate a radio interface for each of the plurality of channel connectors, detect assertion of a keying signal from a first data modem connected to a first channel connector of the plurality of channel connectors, generate clock signals at a configured baud rate in response to detecting the assertion of the keying signal, receive digital data from the first data modem via the first channel connector, and route the received digital data to one or more second channel connectors of the plurality of channel connectors based on a stored connectivity configuration.

According to other aspects of the present disclosure, the radio interface emulator system may include one or more of the following features. The processing circuitry may be further configured to store the connectivity configuration in non-volatile memory. The display may include a touchscreen configured to receive user input for selecting a baud rate from a plurality of baud rate options. The processing circuitry may be further configured to selectively invert digital data output relative to digital data input based on a transmit invert setting. The radio interface emulator system may further include a host port connector disposed on the rear panel and coupled to the processing circuitry, the host port connector configured to receive commands from an external host device for controlling the radio interface emulator system. The processing circuitry may be further configured to assert a key monitor output signal to a data modem connected to a channel connector to emulate a radio microphone keying condition.

According to another aspect of the present disclosure, a method for emulating radio frequency connectivity among a plurality of data modems is provided. The method includes receiving, at a radio interface emulator, a keying signal from a first data modem connected to a first channel of the radio interface emulator. The method includes, after a configurable delay period following receipt of the keying signal, generating clock signals at a selected baud rate. The method includes transmitting the clock signals to the first data modem. The method includes receiving digital data from the first data modem synchronously with the clock signals. The method includes determining, based on a connectivity configuration, one or more second channels to which the digital data is to be routed. The method includes outputting the digital data to one or more second data modems connected to the one or more second channels.

According to other aspects of the present disclosure, the method may include one or more of the following features. The method may further include receiving, via a user interface, a selection of which type of keying signal to monitor for the first channel, wherein the type of keying signal may include one of a push-to-talk signal or a request-to-send signal. The method may further include receiving, via a user interface, user input modifying the connectivity configuration to enable or disable routing of data from the first channel to each of the one or more second channels. The method may further include storing the connectivity configuration and the selected baud rate in non-volatile memory in response to receiving a save command.

The foregoing general description of the illustrative embodiments and the following detailed description thereof are merely exemplary aspects of the teachings of this disclosure and are not restrictive.

### BRIEF DESCRIPTION OF THE DRAWINGS

Some embodiments of the present invention are illustrated as an example and are not limited by the figures of the accompanying drawings, in which like references may indicate similar elements.

FIG. 1 is a block diagram of an apparatus for emulating radio frequency connectivity, according to aspects of the present disclosure.

FIG. 2 illustrates a radio interface emulator system, according to aspects of the present disclosure.

FIG. 3 illustrates a user interface display for the radio interface emulator system, according to aspects of the present disclosure.

FIG. 4 illustrates a data routing configuration, according to aspects of the present disclosure.

FIG. 5 is a flowchart of a method for emulating radio frequency connectivity among a plurality of data modems, according to aspects of the present disclosure.

FIG. 6 illustrates a timing diagram showing a gated clock mode of the radio interface emulator, according to aspects of the present disclosure.

FIG. 7 illustrates a timing diagram showing a continuous clock mode of the radio interface emulator, according to aspects of the present disclosure.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

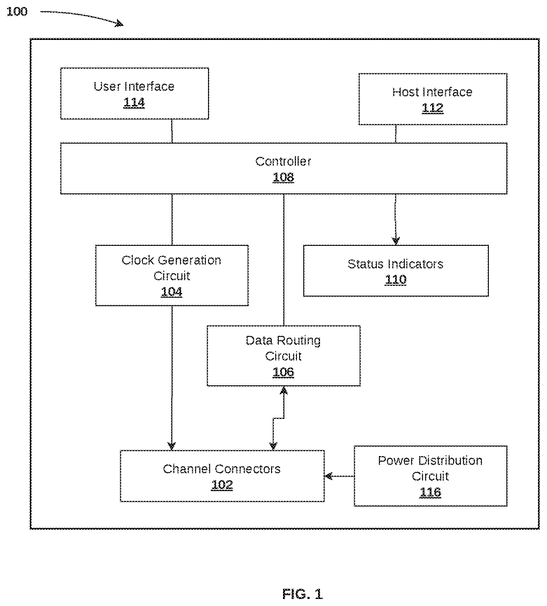

An embodiment of the invention, as shown and described by the various figures and accompanying text, provides an apparatus 100 for emulating radio frequency connectivity among a plurality of channels as illustrated in FIG. 1. The apparatus 100 may provide a functional network consisting of nodes sourced from Improved Data Modem (IDM) channels without requiring a radio frequency environment. In some aspects, the apparatus 100 may support up to five IDM channels for network connectivity emulation. The apparatus 100 may emulate a radio interface for each channel and emulate the radio frequency connectivity among the connected channels.

The apparatus 100 includes a controller 108 that coordinates operation of the apparatus 100. The controller 108 is coupled to a user interface 114 and a host interface 112 for receiving configuration inputs. The user interface 114 may be configured to receive user input to modify a connectivity configuration of the apparatus 100. In some cases, the user interface 114 may comprise a touchscreen display that allows a user to configure and display a commanded state of the apparatus 100 without requiring a host interface connection.

The host interface 112 is coupled to the controller 108 and may be configured to receive commands from an external host device to modify the connectivity configuration and operational parameters of the apparatus 100. In some aspects, the host interface 112 may implement a series of host-initiated, text-based commands for automated control purposes. The host interface 112 may allow an external host device to control channel connectivity configuration, power settings, baud rate selection, and other operational parameters of the apparatus 100.

The controller 108 is further coupled to a clock generation circuit 104 and a data routing circuit 106. The clock generation circuit 104 generates clock signals at a selectable baud rate and provides the clock signals to a plurality of channel connectors 102. The data routing circuit 106 is coupled to the plurality of channel connectors 102 and is configured to receive digital data from a transmitting channel and selectively route the received digital data to one or more receiving channels based on a connectivity configuration. A power distribution circuit 116 provides power to the channel connectors 102. Status indicators 110 indicate operational states of the respective channels.

The clock generation circuit 104 is configured to generate clock signals at a selectable baud rate. The clock signals are provided to a plurality of channel connectors 102. Each channel connector 102 is configured to interface with a respective data modem. In some aspects, the clock generation circuit 104 may support multiple baud rate options including, by way of example, and not as a limitation, 1200, 2400, 4800, 8000, 16000, and a custom baud rate. The selected baud rate determines the clock rate of clock output signals provided to the channel connectors 102.

The data routing circuit 106 is coupled to the plurality of channel connectors 102. The data routing circuit 106 is configured to receive digital data from a transmitting channel of the plurality of channel connectors 102. The data routing circuit 106 selectively routes the received digital data to one or more receiving channels of the plurality of channel connectors 102 based on a connectivity configuration. The connectivity configuration determines which receiving channels receive data from the transmitting channel. In some cases, the connectivity configuration may specify that data from a transmitting channel is routed to all other channels, a subset of channels, or no other channels.

As described above, the controller 108 may be configured to detect a keying signal asserted by a data modem connected to the transmitting channel. In response to detecting the keying signal, the controller 108 may initiate transmission of the clock signals to the transmitting channel after a configurable delay period. The keying signal may comprise one of a push-to-talk signal or a request-to-send signal. The controller 108 may be configured to select which of the push-to-talk signal or the request-to-send signal to monitor for each channel.

The power distribution circuit 116 may be configured to selectively provide power to each of the plurality of channel connectors 102 based on a channel power configuration. The power distribution circuit 116 may provide a voltage to each channel connector 102 when power is enabled for the respective channel. The channel power configuration may be set independently for each channel, allowing selective power distribution to connected data modems.

The apparatus 100 may include a plurality of status indicators 110. Each status indicator 110 is associated with a respective channel connector 102. Each status indicator 110 is configured to indicate at least one of a power status, a transmit status, a receive status, or a keyed status for the respective channel. A power status indicator may illuminate when power is applied to the respective channel. A transmit status indicator may illuminate whenever the channel is actively transmitting data. A receive status indicator may illuminate whenever there is network data activity and the particular channel is connected to a transmitting channel. A keyed status indicator may illuminate whenever the selected keying signal for the channel is asserted.

The controller 108 may be configured to detect a keying signal asserted by a data modem connected to a transmitting channel. The keying signal may comprise one of a push-to-talk (PTT) signal or a request-to-send (RTS) signal. The controller 108 may be configured to select which of the push-to-talk signal or the request-to-send signal to monitor for each channel. The PTT keying signal may be implemented as an open-collector signal from the data modem. The open-collector PTT signal may be used with analog data interfaces where the data modem performs baseband modulation and demodulation. The RTS signal may be a digital keying signal used with synchronous serial data interfaces.

The clock generation circuit 104 may operate in one of two clock modes: a gated clock mode or a continuous clock mode. In the gated clock mode, the clock generation circuit 104 may be configured to generate a gated clock signal that is initiated in response to the keying signal being asserted. In the gated clock mode, the clock generation circuit 104 may source clock signals at the configured baud rate to initiate data transfer after the configurable delay period. The data modem clocks in bits synchronously with the inbound gated clock signal.

When operating in the continuous clock mode, the clock generation circuit 104 is configured to generate a continuous clock signal. The continuous clock signal runs at all times regardless of whether a keying signal is asserted. In the continuous clock mode, the controller 108 is configured to assert a clear-to-send (CTS) signal to the transmitting channel after the configurable delay period to qualify clock edges for data transfer. The CTS signal forms a handshaking mechanism with the data modem to signify qualified clocks. On transmission, the data modem sources data on clock transitions only when the CTS signal is asserted.

The data routing circuit 106 is configured to receive digital data from a transmitting channel and selectively route the received digital data to one or more receiving channels based on a connectivity configuration. The data routing circuit 106 may be further configured to receive analog data from the transmitting channel and selectively route the received analog data to the one or more receiving channels based on the connectivity configuration.

The apparatus 100 supports analog amplitude-shift keying (ASK) data connectivity. The analog data interface may support wideband ASK data transfer at rates up to 16 kb/s. The analog data interface may also support narrowband audio frequency-shift keying (FSK) data transfer at rates up to 1200 baud. From a wiring perspective, the analog data interface includes an analog transmit signal path and an analog receive signal path. The data modem may be responsible for baseband modulation and baseband demodulation of the desired ASK or FSK data pattern at the configured baud rate.

The analog data interface may support analog signals of +/-10V for ASKIN and ASKOUT signals. The ASKIN signal may comprise an analog input signal received from a data modem connected to a transmitting channel. The ASKOUT signal may comprise an analog output signal transmitted to a data modem connected to a receiving channel. The data routing circuit may receive the analog data via the ASKIN signal from the transmitting channel and selectively route the analog data via the ASKOUT signal to the one or more receiving channels based on the connectivity configuration.

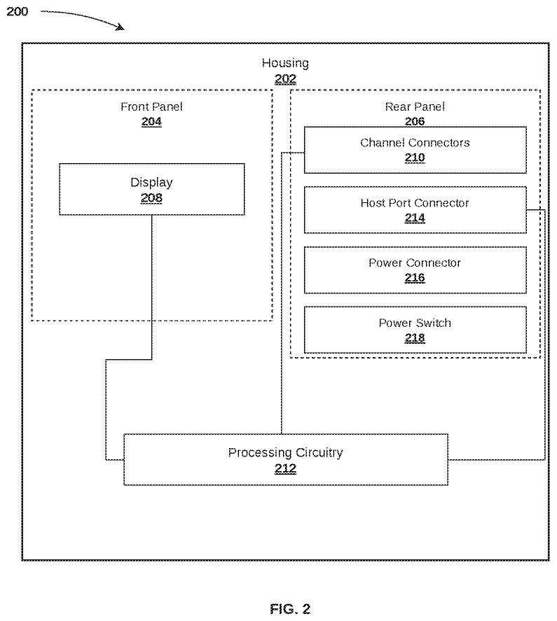

FIG. 2 illustrates a radio interface emulator system 200 according to various aspects of the present disclosure. The radio interface emulator system 200 includes a housing 202 having a front panel 204 and a rear panel 206. A display 208 is disposed on the front panel 204. The display 208 is configured to present a user interface for configuring the radio interface emulator system 200. The display 208 may comprise a touchscreen display that allows a user to control various functions and settings of the radio interface emulator system 200.

A plurality of channel connectors 210 are disposed on the rear panel 206. Each channel connector 210 is configured to connect to a data modem channel. By way of example, and not as a limitation, each channel connector 210 may comprise a DB25 female connector. Each channel connector 210 provides signal and power connections to an individual modem channel. The signal connections may include digital data signals, clock signals, keying signals, and control signals. The power connections may provide a voltage to a connected data modem when power is enabled for the respective channel.

Processing circuitry 212 is disposed within the housing 202 and is coupled to the plurality of channel connectors 210 and the display 208. The processing circuitry 212 is configured to emulate a radio interface for each of the plurality of channel connectors 210. The processing circuitry 212 is configured to detect assertion of a keying signal from a first data modem connected to a first channel connector of the plurality of channel connectors 210. In response to detecting the assertion of the keying signal, the processing circuitry 212 generates clock signals at a configured baud rate. The processing circuitry 212 receives digital data from the first data modem via the first channel connector. The processing circuitry 212 routes the received digital data to one or more second channel connectors of the plurality of channel connectors 210 based on a stored connectivity configuration.

A host port connector 214 may be disposed on the rear panel 206 and coupled to the processing circuitry 212. The host port connector 214 is configured to receive commands from an external host device for controlling the radio interface emulator system 200. The host port connector 214 may comprise a USB 2.0 Type-A connector. By way of example, and not as a limitation, the host port connector 214 may operate as a USB COM port with a speed of 115200 baud, 8-bit data, no parity, 1 stop bit, and no flow control.

The host interface may implement a text-based command protocol. The text-based command protocol may comprise a series of host-initiated commands, with each command terminating with a text-based response from the radio interface emulator system 200. The text-based command protocol may include commands for controlling channel connectivity configuration, timing parameters, keying signal selection, key monitor output, data inversion settings, power settings, version information, and baud rate selection. In some aspects, the text-based commands may include a CONN command for establishing transmit connectivity paths, a SYNC command for synchronizing to hardware settings, a KEY_TO_CLK command for setting or getting the key-to-clock delay time, a KEY_TO_CTS command for setting or getting the key-to-CTS delay time, a TX_KEY command for setting or getting the keying signal selection for a channel, a KEYMON command for asserting or de-asserting the key monitor output, a DATA_INVERT command for enabling or disabling transmit data inversion, a PWR command for applying or removing power to a channel, a VER command for getting the software version, a BAUD command for setting or getting the current baud rate, and a PROG_BAUD command for getting the programmable baud rate.

The radio interface emulator system 200 may also include a power connector 216 disposed on the rear panel 206. The power connector 216 may comprise a power jack connector having a 2.1 mm inner diameter and a 5.5 mm outer diameter. The power connector 216 is configured to receive incoming power for the radio interface emulator system 200. The radio interface emulator system 200 may accept input power between +12V and +30V DC via the power connector 216.

A power switch 218 may be disposed on the rear panel 206. The power switch 218 may be configured to apply or remove external power to the radio interface emulator system 200. When the power switch 218 is in an ON position, external power is applied to the radio interface emulator system 200. When the power switch 218 is in an OFF position, external power is removed from the radio interface emulator system 200.

The radio interface emulator system 200 may include a fuse holder configured to hold a replaceable fuse. The fuse holder may protect internal electronics of the radio interface emulator system 200 from overcurrent conditions. The replaceable fuse may have a size of 5 mm×20 mm.

Each channel connector 210 may provide power connections to a connected data modem. Each channel connector 210 may include IDM PWR pins configured to supply 28 VDC nominal power to a data modem connected to the respective channel connector 210. The power supplied via the IDM PWR pins may be selectively enabled or disabled for each channel based on a channel power configuration. When power is enabled for a channel, the IDM PWR pins supply power to the connected data modem. When power is disabled for a channel, the IDM PWR pins do not supply power to the connected data modem.

The digital data interface of the apparatus may use RS-232 signaling for communication between the apparatus and connected data modems. The RS-232 signaling may be implemented for a plurality of signals including a DATAIN signal, a DATAOUT signal, a CCLK signal, a GCLK signal, an RTS signal, and a CTS signal. The DATAIN signal may comprise a digital data input signal sourced from a data modem transmit path. The DATAOUT signal may comprise a digital data output signal transmitted to a data modem receive path. The CCLK signal may comprise a continuous clock output signal provided to a connected data modem. The GCLK signal may comprise a gated clock output signal provided to a connected data modem. The RTS signal may comprise a request-to-send input signal received from a data modem transmit path. The CTS signal may comprise a clear-to-send output signal transmitted to a data modem transmit path.

Each channel connector may include general purpose input signals and general purpose output signals for additional modem interfacing. The general purpose input signals may include a GPI_0 signal and a GPI_1 signal. The general purpose output signals may include a GPO_0 signal and a GPO_1 signal. The general purpose input signals and general purpose output signals may provide additional interfacing capabilities between the apparatus and connected data modems.

The apparatus 200 may include an Ethernet host port connector for network connectivity. In some aspects, the Ethernet host port connector may comprise an RJ-45 connector configured for 10/100 BASE-T Ethernet connectivity. The Ethernet host port connector may provide an alternative interface for receiving commands from an external host device for controlling the apparatus. The apparatus may have a static IP address for Ethernet connectivity. The apparatus may have a MAC address for Ethernet connectivity.

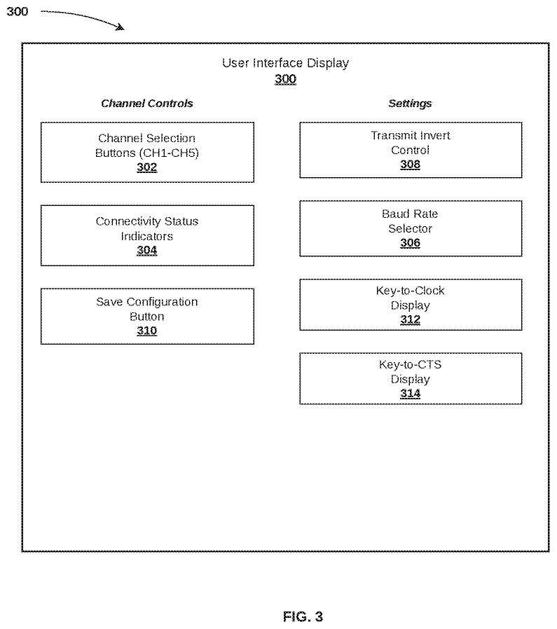

FIG. 3 illustrates a user interface display 300 for the radio interface emulator system according to various aspects of the present disclosure. The user interface display 300 may be presented on a touchscreen display disposed on a front panel of the radio interface emulator system. The user interface display 300 may comprise a main menu that displays upon startup of the radio interface emulator system.

The user interface display 300 includes a plurality of channel selection buttons 302 for selecting individual channel configurations. The channel selection buttons 302 may comprise five channel buttons labeled CH1 through CH5. Pressing a channel selection button 302 may navigate the user interface display 300 to a respective channel menu display for configuring the selected channel. The channel selection buttons 302 allow a user to access configuration settings for each individual channel of the radio interface emulator system.

The user interface display 300 includes a plurality of connectivity status indicators 304 for displaying channel connectivity. Each connectivity status indicator 304 may be associated with a respective channel selection button 302. A connectivity status indicator 304 may display as a filled dark gray color when the respective channel is connected to other channels. A connectivity status indicator 304 may display as an unfilled box when the respective channel is disconnected. The connectivity status indicators 304 provide a visual indication of the current connectivity configuration for each of the plurality of channel connectors.

The user interface display 300 includes a baud rate selector 306 for selecting a baud rate from a plurality of baud rate options. The baud rate selector 306 may cycle through each of the baud rate options for digital data. By way of example, and not as a limitation, the baud rate options may include 1200, 2400, 4800, 8000, 16000, and a custom programmable baud rate. The custom programmable baud rate may be altered through a host interface. The selected baud rate determines the clock rate of clock output signals provided to connected data modems. The baud rate selector 306 allows a user to configure the baud rate via the touchscreen display without requiring a host interface connection.

The user interface display 300 includes a transmit invert control 308. The transmit invert control 308 may be configured to selectively invert digital data output relative to digital data input based on a transmit invert setting. The transmit invert control 308 may comprise a slider control that may be set to an ON position or an OFF position. When the transmit invert control 308 is in the ON position, the processing circuitry may invert the digital data output (DATAOUT) with reference to the digital data input (DATAIN) by applying a logical NOT operation. When the transmit invert control 308 is in the OFF position, the digital data output is not inverted relative to the digital data input.

The user interface display 300 includes a save configuration button 310. The save configuration button 310 may be configured to store settings to non-volatile memory. Pressing the save configuration button 310 causes the processing circuitry to store a connectivity configuration and operational parameters in non-volatile memory. The stored settings may include the connectivity configuration, the selected baud rate, timing parameters, and other operational settings.

The user interface display 300 includes a key-to-clock display 312 and a key-to-CTS display 314. The key-to-clock display 312 may display a current value for a key-to-clock delay time in milliseconds. The key-to-CTS display 314 may display a current value for a key-to-CTS delay time in milliseconds. The key-to-clock delay time and the key-to-CTS delay time may be altered via a host interface. In an initial state of the apparatus, the key-to-clock delay time may be set to 2 milliseconds and the key-to-CTS delay time may be set to 2 milliseconds.

The baud rate selector 306 may cycle through baud rate options, which may include, but are not limited to, 1200, 2400, 4800, 8000, 16000, and a custom programmable baud rate. In an initial state of the apparatus, the default baud rate may be set to 16000 and the custom baud rate may be set to 5000. The custom programmable baud rate may be altered via the host interface.

The processing circuitry may be configured to assert a key monitor output signal to a data modem connected to a channel connector to emulate a radio microphone keying condition. The key monitor output signal may comprise a KEYMON signal that is output to a connected data modem. When the key monitor output signal is asserted, the key monitor output signal emulates a condition in which a radio microphone is keyed. The key monitor output signal may be selectively asserted or de-asserted for each channel independently. The user interface may include a key monitor control for each channel that allows a user to change the state of the key monitor output signal. The key monitor control may be set to an ON position to assert the key monitor output signal or an OFF position to de-assert the key monitor output signal. The key monitor output signal may also be controlled via the host interface using text-based commands to assert or de-assert the key monitor output signal for a specified channel.

The apparatus may display a splash screen during an initialization sequence. When the apparatus is powered on, the apparatus begins the initialization sequence. The initialization sequence may be visually identified by the splash screen displayed on the display. After the initialization sequence is complete, the splash screen may transition to a main menu. The main menu may comprise the user interface display that allows a user to configure the apparatus and view operational status of the plurality of channel connectors.

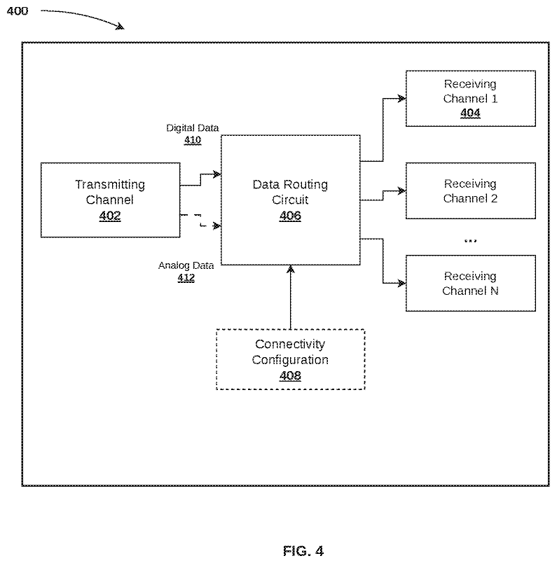

FIG. 4 illustrates a possible embodiment of a data routing configuration 400 of the present disclosure. The data routing configuration 400 depicts how data is routed from a transmitting channel to one or more receiving channels based on a connectivity configuration.

A transmitting channel 402 provides data to a data routing circuit 406. The transmitting channel 402 may comprise a channel connector connected to a data modem that is actively transmitting data. The transmitting channel 402 may provide data via a digital data path 410 and an analog data path 412 to the data routing circuit 406. The digital data path 410 may carry synchronous serial digital data received from a data modem transmit path. The analog data path 412 may carry analog data such as amplitude-shift keying (ASK) data or frequency-shift keying (FSK) data received from a data modem transmit path.

The data routing circuit 406 is configured to selectively route the received data to one or more receiving channels 404 based on a connectivity configuration 408. The connectivity configuration 408 determines which receiving channels 404 receive data from the transmitting channel 402. The connectivity configuration 408 may specify that data from the transmitting channel 402 is routed to all other channels, a subset of channels, or no other channels. The connectivity configuration 408 may be modified via a user interface or a host interface.

Each receiving channel 404 may comprise a channel connector connected to a data modem that is configured to receive data. The data routing circuit 406 may route digital data via the digital data path 410 to the one or more receiving channels 404. The data routing circuit 406 may route analog data via the analog data path 412 to the one or more receiving channels 404. In some cases, the data routing circuit 406 may pass data received from the transmitting channel 402 to a particular receiving channel 404 when the connectivity configuration 408 indicates that the receiving channel 404 is connected to the transmitting channel 402. When the connectivity configuration 408 indicates that a receiving channel 404 is not connected to the transmitting channel 402, the data routing circuit 406 may not route data to that particular receiving channel 404.

The connectivity configuration 408 may be independently configured for each channel. For each channel acting as a transmitting channel 402, the connectivity configuration 408 may specify which other channels are designated as receiving channels 404 for data from the transmitting channel 402. The connectivity configuration 408 may be stored in non-volatile memory and may persist across power cycles of the apparatus.

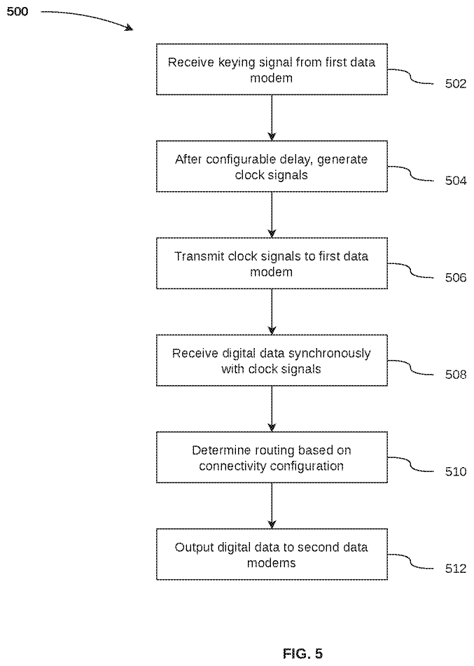

FIG. 5 illustrates a flowchart of a method 500 for emulating radio frequency connectivity among a plurality of data modems. The method 500 may be performed by a radio interface emulator, such as the apparatus 100 described above with reference to FIG. 1 or the radio interface emulator system 200 described above with reference to FIG. 2.

At a step 502, the method 500 includes receiving, at a radio interface emulator, a keying signal from a first data modem connected to a first channel of the radio interface emulator. The keying signal may comprise one of a push-to-talk (PTT) signal or a request-to-send (RTS) signal. The PTT signal may comprise an open-collector keying signal that is asserted by the first data modem to initiate and bound a transmission process. The RTS signal may comprise a digital keying signal used with synchronous serial data interfaces. The radio interface emulator may be configured to select which type of keying signal to monitor for the first channel. In some cases, the selection of which keying signal to monitor may be configured via a user interface or a host interface of the radio interface emulator.

At a step 504, after a configurable delay period following receipt of the keying signal, the method 500 includes generating clock signals at a selected baud rate. The configurable delay period may comprise a key-to-clock delay time or a key-to-CTS delay time depending on a clock mode of the radio interface emulator. The configurable delay period may be set to a value in milliseconds. The selected baud rate may be chosen from a plurality of baud rate options. In some cases, the baud rate options may include 1200, 2400, 4800, 8000, 16000, and a custom programmable baud rate. The selected baud rate determines the clock rate of the clock signals provided to the first data modem.

At a step 506, the method 500 includes transmitting the clock signals to the first data modem. In a gated clock mode, the clock signals may comprise a gated clock signal that is initiated in response to the keying signal being asserted. In the gated clock mode, the radio interface emulator sources the clock signals at the selected baud rate to initiate data transfer after the configurable delay period. The first data modem may clock in bits synchronously with the inbound gated clock signal. In a continuous clock mode, the clock signals may comprise a continuous clock signal that runs at all times regardless of whether the keying signal is asserted. In the continuous clock mode, the radio interface emulator may assert a clear-to-send (CTS) signal to the first data modem after the configurable delay period to qualify clock edges for data transfer. The CTS signal forms a handshaking mechanism with the first data modem to signify qualified clocks. On transmission, the first data modem may source data on clock transitions only when the CTS signal is asserted.

At a step 508, the method 500 includes receiving digital data from the first data modem synchronously with the clock signals. The first data modem may source digital data on clock transitions. In the gated clock mode, the first data modem may clock out bits synchronously with the gated clock signal provided by the radio interface emulator. In the continuous clock mode, the first data modem may source data on clock transitions only when the clear-to-send signal is asserted. The radio interface emulator may receive the digital data via a digital data input signal from the first data modem transmit path.

At a step 510, the method 500 includes determining, based on a connectivity configuration, one or more second channels to which the digital data is to be routed. The connectivity configuration may specify which channels are designated as receiving channels for data from the first channel acting as a transmitting channel. The connectivity configuration may specify that data from the first channel is routed to all other channels, a subset of channels, or no other channels. The connectivity configuration may be independently configured for each channel.

At a step 512, the method 500 includes outputting the digital data to one or more second data modems connected to the one or more second channels. The radio interface emulator may output the digital data via a digital data output signal to each of the one or more second data modems. In some cases, the radio interface emulator may pass data received from the first channel to a particular second channel when the connectivity configuration indicates that the second channel is connected to the first channel. When the connectivity configuration indicates that a second channel is not connected to the first channel, the radio interface emulator may not route data to that particular second channel.

The method 500 may further comprise receiving, via a user interface, a selection of which type of keying signal to monitor for the first channel. The type of keying signal may comprise one of a push-to-talk signal or a request-to-send signal. The user interface may include a control that may be set to a push-to-talk position or a request-to-send position to determine which modem-sourced keying signal the radio interface emulator monitors to detect a channel transmission. The selection of which keying signal to monitor may also be configured via a host interface of the radio interface emulator.

The method 500 may further comprise receiving, via a user interface, user input modifying the connectivity configuration to enable or disable routing of data from the first channel to each of the one or more second channels. The user interface may include channel output control buttons for each channel. Each channel output control button may represent one of the other channels. When a channel output control button is enabled, the radio interface emulator may pass data received from the channel transmit path to the particular other channel receive path. When a channel output control button is disabled, the radio interface emulator may not route data to that particular other channel.

The method 500 may further comprise storing the connectivity configuration and the selected baud rate in non-volatile memory in response to receiving a save command. The user interface may include a save configuration button that, when pressed, causes the radio interface emulator to store the connectivity configuration and operational parameters in non-volatile memory. The stored settings may persist across power cycles of the radio interface emulator.

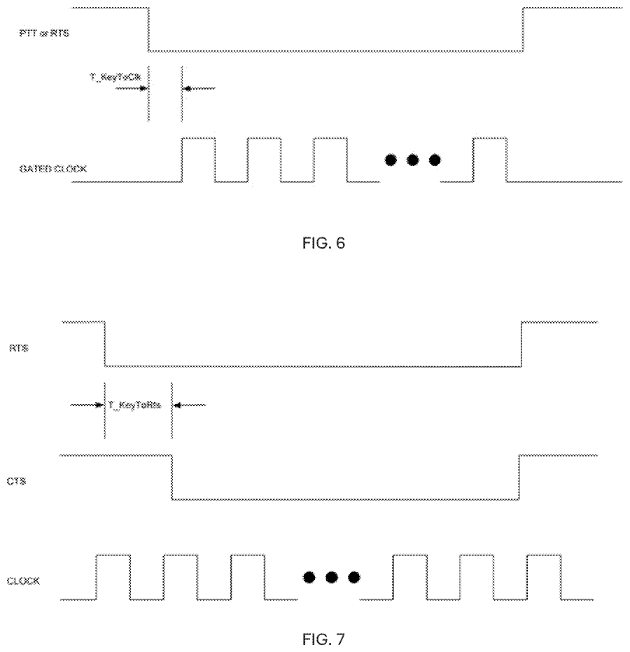

FIG. 6 illustrates a timing diagram showing a gated clock mode of the radio interface emulator according to various aspects of the present disclosure. The timing diagram of FIG. 6 depicts the temporal relationships between a keying signal (PTT or RTS) and the gated clock signal.

The timing diagram of FIG. 6 shows a keying signal that is asserted by a data modem to initiate a transmission. The keying signal may comprise one of a push-to-talk (PTT) signal or a request-to-send (RTS) signal depending on the configuration of the radio interface emulator. A configurable delay period (T_KeyToClk) follows the assertion of the keying signal. The configurable delay period may be set to a value in milliseconds. The configurable delay period may be set to 2 milliseconds in an initial state of the apparatus.

In the gated clock mode, the timing diagram of FIG. 6 shows a gated clock signal that is initiated after the configurable delay period following assertion of the keying signal. The gated clock signal is not present prior to the assertion of the keying signal. After the configurable delay period elapses, the radio interface emulator sources the gated clock signal at a configured baud rate to initiate data transfer. The data modem clocks in bits synchronously with the inbound gated clock signal. On the receive side, the data modem may sample clocks in an attempt to identify and recover transmission units.

FIG. 7 illustrates a timing diagram showing a continuous clock mode of the radio interface emulator according to various aspects of the present disclosure. The timing diagram of FIG. 7 depicts the temporal relationships between a keying signal (RTS) and the continuous clock signal.

The timing diagram of FIG. 7 shows a continuous clock signal that runs at all times regardless of whether the keying signal is asserted. The continuous clock signal is present both before and after the assertion of the keying signal. In the continuous clock mode, a clear-to-send signal (CTS) is asserted after the configurable delay period to qualify clock edges for data transfer. The clear-to-send signal forms a handshaking mechanism with the data modem to signify qualified clocks. On transmission, the data modem sources data on clock transitions only when the clear-to-send signal is asserted. The clear-to-send signal may remain asserted for the duration of the transmission and may be de-asserted when the keying signal is de-asserted.

The configurable delay period may comprise a key-to-clock delay time in the gated clock mode or a key-to-CTS delay time in the continuous clock mode. The key-to-clock delay time and the key-to-CTS delay time may be independently configured via a host interface of the radio interface emulator. In some cases, the key-to-clock delay time and the key-to-CTS delay time may be displayed on a user interface display of the radio interface emulator.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. An apparatus for emulating radio frequency connectivity among a plurality of channels, the apparatus comprising:
a plurality of channel connectors, each channel connector configured to interface with a respective data modem;
a clock generation circuit configured to generate clock signals at a selectable baud rate, the clock signals provided to the plurality of channel connectors;
a data routing circuit coupled to the plurality of channel connectors, the data routing circuit configured to:
receive digital data from a transmitting channel of the plurality of channel connectors; and
selectively route the received digital data to one or more receiving channels of the plurality of channel connectors based on a connectivity configuration; and
a controller coupled to the data routing circuit and the clock generation circuit, the controller configured to:
detect a keying signal asserted by a data modem connected to the transmitting channel; and
in response to detecting the keying signal, initiate transmission of the clock signals to the transmitting channel after a configurable delay period.

2. The apparatus of claim 1, wherein the keying signal comprises one of a push-to-talk signal or a request-to-send signal, and wherein the controller is further configured to select which of the push-to-talk signal or the request-to-send signal to monitor for each channel.

3. The apparatus of claim 1, wherein the clock generation circuit is configured to generate a gated clock signal that is initiated in response to the keying signal being asserted.

4. The apparatus of claim 1, wherein the clock generation circuit is configured to generate a continuous clock signal, and wherein the controller is further configured to assert a clear-to-send signal to the transmitting channel after the configurable delay period to qualify clock edges for data transfer.

5. The apparatus of claim 1, further comprising a user interface coupled to the controller, the user interface configured to receive user input to modify the connectivity configuration.

6. The apparatus of claim 5, wherein the user interface comprises a touchscreen display configured to display a main menu including channel selection buttons and connectivity status indicators for each of the plurality of channel connectors.

7. The apparatus of claim 1, further comprising a power distribution circuit configured to selectively provide power to each of the plurality of channel connectors based on a channel power configuration.

8. The apparatus of claim 1, wherein the data routing circuit is further configured to:
receive analog data from the transmitting channel; and
selectively route the received analog data to the one or more receiving channels based on the connectivity configuration.

9. The apparatus of claim 1, further comprising a plurality of status indicators, each status indicator associated with a respective channel connector and configured to indicate at least one of a power status, a transmit status, a receive status, or a keyed status for the respective channel.

10. The apparatus of claim 1, further comprising a host interface coupled to the controller, the host interface configured to receive commands from an external host device to modify the connectivity configuration and operational parameters of the apparatus.

11. A radio interface emulator system comprising:
a housing having a front panel and a rear panel;
a plurality of channel connectors disposed on the rear panel, each channel connector configured to connect to a data modem channel;
a display disposed on the front panel and configured to present a user interface for configuring the radio interface emulator system;
processing circuitry disposed within the housing and coupled to the plurality of channel connectors and the display, the processing circuitry configured to:
emulate a radio interface for each of the plurality of channel connectors;
detect assertion of a keying signal from a first data modem connected to a first channel connector of the plurality of channel connectors;
generate clock signals at a configured baud rate in response to detecting the assertion of the keying signal;
receive digital data from the first data modem via the first channel connector; and
route the received digital data to one or more second channel connectors of the plurality of channel connectors based on a stored connectivity configuration.

12. The radio interface emulator system of claim 11, wherein the processing circuitry is further configured to store the connectivity configuration in non-volatile memory.

13. The radio interface emulator system of claim 11, wherein the display comprises a touchscreen configured to receive user input for selecting a baud rate from a plurality of baud rate options.

14. The radio interface emulator system of claim 11, wherein the processing circuitry is further configured to selectively invert digital data output relative to digital data input based on a transmit invert setting.

15. The radio interface emulator system of claim 11, further comprising a host port connector disposed on the rear panel and coupled to the processing circuitry, the host port connector configured to receive commands from an external host device for controlling the radio interface emulator system.

16. The radio interface emulator system of claim 11, wherein the processing circuitry is further configured to assert a key monitor output signal to a data modem connected to a channel connector to emulate a radio microphone keying condition.

17. A method for emulating radio frequency connectivity among a plurality of data modems, the method comprising the steps of:
receiving, at a radio interface emulator, a keying signal from a first data modem connected to a first channel of the radio interface emulator;
after a configurable delay period following receipt of the keying signal, generating clock signals at a selected baud rate;
transmitting the clock signals to the first data modem;
receiving digital data from the first data modem synchronously with the clock signals;
determining, based on a connectivity configuration, one or more second channels to which the digital data is to be routed; and
outputting the digital data to one or more second data modems connected to the one or more second channels.

18. The method of claim 17, further comprising the step of:
receiving, via a user interface, a selection of which type of keying signal to monitor for the first channel, wherein the type of keying signal comprises one of a push-to-talk signal or a request-to-send signal.

19. The method of claim 17, further comprising the step of:
receiving, via a user interface, user input modifying the connectivity configuration to enable or disable routing of data from the first channel to each of the one or more second channels.

20. The method of claim 17, further comprising the step of:
storing the connectivity configuration and the selected baud rate in non-volatile memory in response to receiving a save command.
